(19) United States
(12) Patent Application Publication
(10) Pub. No.: US 2019/0289453 A1
(43) Pub. Date: Sep. 19, 2019

(54) METHOD AND APPARATUS FOR CONFIGURING MULTI-HOP NETWORK

(71) Applicant: SEOUL NATIONAL UNIVERSITY R&DB FOUNDATION, Seoul (KR)

(72) Inventors: Seowoo JANG, Seongnam-si (KR); Saewoong BAHK, Seoul (KR); Taeseop LEE, Seoul (KR); Myungsup LEE, Daegu (KR)

(73) Assignee: Seoul National University R&DB Foundation, Seoul (KR)

(21) Appl. No.: 16/318,175

(22) PCT Filed: Nov. 18, 2016
(86) PCT No.: PCT/KR2016/013339

§ 371 Date: Jan. 16, 2019

(30) Foreign Application Priority Data
Aug. 8, 2016 (KR) 10-2016-0100859

(51) Int. Cl. H04W 8/00; H04L 12/801

(52) U.S. Cl. CPC H04W 8/005; H04W 84/12; H04L 47/17

(57) ABSTRACT

Provided are a device and method for configuring a multi-hop network. The device includes a controller configured to set a second multi-hop network including some terminals of a first multi-hop network, the first multi-hop network being built using a low-power communication interface, and the second multi-hop network being built using a communication interface having a longer transmission distance than in the first multi-hop network.

### TECHNICAL FIELD

The present invention relates to network configuration, and more particularly, to a method and device for configuring a multi-shop network which includes terminals including a plurality of communication interfaces.

### BACKGROUND ART

Current commercialized user terminals include a plurality of communication interfaces. For example, smartphones include a Long Term Evolution (LTE) interface, a WiFi interface, a Bluetooth interface, etc. The LTE interface establishes a link to a base station and provides voice and data communications. The WiFi interface provides internet communication via a WiFi router. The Bluetooth interface enables a small amount of data to be exchanged with headsets or other peripheral devices over a short distance. Interfaces separately operate according to their design purposes. Each interface establishes a single-hop link to a base station, a router, and a peripheral device and provides a communication function for a user terminal.

An LTE interface and a WiFi interface may communicate with communication infrastructure through only a single-hop link, i.e., a communication range in which wireless signals from a base station and a router can reach. Accordingly, the LTE interface and the WiFi interface may not provide services for communication with infrastructure in communication shadow in which a base station is destroyed or there is no router nearby as in disaster or emergency situations or outdoor leisure environments.

A Bluetooth interface may set a link to another terminal without infrastructure but enables only a single-hop link. Accordingly, when another terminal is beyond a single-hop range, communication with the terminal is not possible.

When a multi-hop network is configured using a single interface to cope with communication shadow, it goes beyond the original design purposes of the interface. As a result, an LTE interface and a WiFi interface have a difficulty to keep a network due to high energy consumption. Although a Bluetooth interface has low energy consumption in light of original design purposes, it has a short communication range. In addition, when high-throughput low-delay communication services are needed in communication shadow, the services may not be provided with only Bluetooth interface.

As such, a multi-hop network may not be efficiently configured using only a single communication interface in terms of service provision and may not be efficiently configured using all type of communication interfaces in terms of energy.

### DESCRIPTION OF THE INVENTION

### Technical Problem

Provided are a method and device for configuring a multi-hop network, which uses low power and enables high-throughput low-delay communication when necessary, and a computer-readable recording medium for recording a program for executing the method.

### Solution to Problem

According to an aspect of the present invention, a method of configuring a multi-hop network includes setting a second network including some terminals of a first network, the first network and the second network being the multi-hop network, the first network being built using a first communication interface characterized by low power, and the second network being built using a second communication interface having a longer transmission distance than in the first network.

According to an embodiment of the present invention, the setting of the second network may include turning on the second communication interface based on a route sequence for the first network.

According to an embodiment of the present invention, the setting of the second network may include broadcasting a device discovery message through the second communication interface based on a route sequence for the first network; and obtaining information on a plurality of adjacent terminals based on a device discovery message received from each of the plurality of adjacent terminals through the second communication interface.

According to an embodiment of the present invention, the device discovery message may be a WiFi beacon packet.

According to an embodiment of the present invention, the setting of the second network may include selecting an adjacent terminal from the plurality of adjacent terminals based on the route sequence for the first network, the adjacent terminal being nearest to a destination.

According to an embodiment of the present invention, the second network may include the adjacent terminal nearest to the destination.

According to an embodiment of the present invention, the setting of the second network may include sending an adjacent terminal selection confirmation signal to the adjacent terminal nearest to the destination through the first communication interface.

According to an embodiment of the present invention, the setting of the second network may include turning off the second communication interface when a device performing the method of configuring a multi-hop network is not a source and does not receive the adjacent terminal selection confirmation signal within a certain time.

According to an embodiment of the present invention, the setting of the second network may include broadcasting a control message based on a route sequence for the second network, the control message being for prohibiting channel occupation of terminals which do not participate in the second network.

According to an embodiment of the present invention, the control message may be at least one of a WiFi clear to send (CTS) control packet, a WiFi null data packet, and a Bluetooth control packet.

According to an embodiment of the present invention, the first communication interface may be a Bluetooth interface.

According to an embodiment of the present invention, the second communication interface may be a WiFi interface.

According to another aspect of the present invention, a computer-readable recording medium has recorded thereon a program for executing the method.

According to a further aspect of the present invention, a device for configuring a multi-hop network includes a controller configured to set a second network including some terminals of a first network, the first network and the second network being the multi-hop network, the first network being built using a first communication interface characterized by low power, and the second network being built using a second communication interface having a longer transmission distance than in the first network.

### Advantageous Effects of the Invention

According to the present invention, a multi-hop network may be configured to maintain low-power consumption and enable high-throughput low-delay communication when necessary. For this, a low-power multi-hop network is configured first, and then an optimal high-throughput low-delay multi-hop network including only some terminals of the low-power multi-hop network is set using the low-power multi-hop network when necessary, so that energy consumption is minimized, and therefore, the lifespan of an entire network is maximized and necessary services are effectively provided. Accordingly, a WiFi and Bluetooth Low Energy (WiBLE) network may be effectively used in communication shadow, in which communication with infrastructure is not available, and may have a maximized lifespan as compared to a multi-hop network using a single interface. For example, in disaster or emergency situations in which communication with infrastructure is not available because of the collapse of a building, mobile phones of survivors and robots deployed by rescue teams may form a WiBLE network, thereby enabling the survivors to exchange audio and video signals with the rescue teams, so that a rescue success rate may be increased. In addition, even in communication shadow, in which communication with infrastructure is not available, during outdoor leisure activities, communication environments may be provided for participants in the outdoor leisure activities. In addition, when a low-power multi-hop network is configured, a multi-hop network, which is robust to external interference, may be configured with low power using the frequency hopping characteristics of Bluetooth.

### BRIEF DESCRIPTION OF DRAWINGS

FIG. 1 schematically shows a multi-hop network, which includes terminals including a plurality of communication interfaces, according to an embodiment of the present invention.

FIG. 2 schematically shows configuration of a low-power multi-hop network, according to an embodiment of the present invention.

FIG. 3 schematically shows a protocol stack of a device 300, according to an embodiment of the present invention.

FIG. 4 schematically shows a parent node changing procedure in a low-power multi-hop network, according to an embodiment of the present invention.

FIG. 5 is a flowchart of a procedure for setting a WiFi route of a WiFi and Bluetooth Low Energy (WiBLE) network, according to an embodiment of the present invention.

FIG. 6 schematically shows a structure of a device 600, according to an embodiment of the present invention.

FIG. 7 schematically shows data channel status of the device 600, according to an embodiment of the present invention.

### MODE OF THE INVENTION

Hereinafter, embodiments of the present invention will be described in detail with reference to the accompanying drawings in which like numbers refer to like elements and the sizes of elements may be exaggerated for clarity.

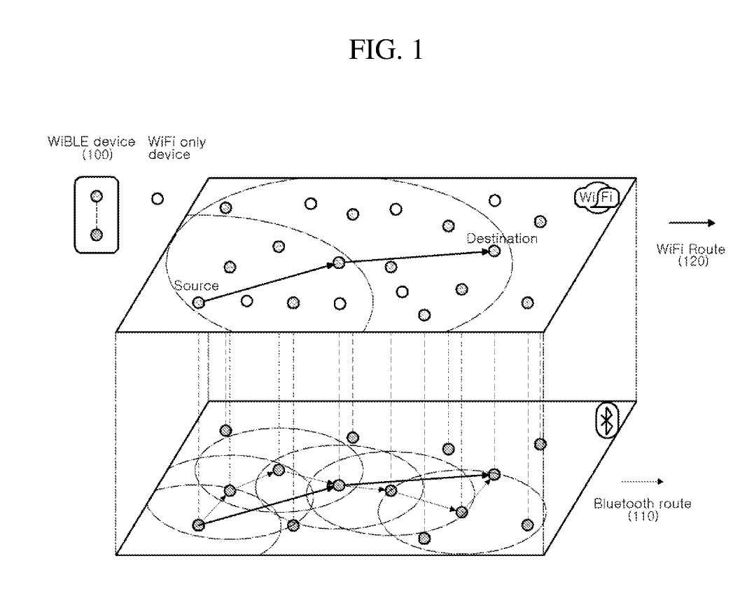

FIG. 1 schematically shows a multi-hop network, which includes terminals including a plurality of communication interfaces, according to an embodiment of the present invention.

According to an embodiment of the present invention, to configure a multi-hop network which uses low power and enables high-throughput low-delay communication when necessary, a low-power multi-hop network is configured first, and then a high-throughput low-delay multi-hop network including only some terminals of the low-power multi-hop network is set when necessary, so that the lifespan of an entire network is maximized and necessary services are effectively provided. Since high-throughput low-delay multi-hop network technology usually provides a longer transmission distance than low-power multi-hop network technology, the high-throughput low-delay multi-hop network may be set using only some terminals of the low-power multi-hop network.

According to an embodiment of the present invention, a low-power multi-hop network may be configured using Bluetooth Low Energy (BLE) technology, but the present invention is not limited thereto. It is apparent to those skilled in the art that a low-power multi-hop network may be configured using other low-power communication technology. In addition, according to an embodiment of the present invention, a high-throughput low-delay multi-hop network may be configured using WiFi technology, but the present invention is not limited thereto. It is apparent to those skilled in the art that a high-throughput low-delay multi-hop network may be configured using other high-throughput low-delay communication technology.

According to an embodiment of the present invention, a multi-hop network, which uses low power and enables high-throughput low-delay communication when necessary, is defined as a WiFi and BLE (WiBLE) network. A terminal including a plurality of interface in the WiBLE network is defined as a WiBLE device 100. In a WiBLE network shown in FIG. 1, a Bluetooth route 110 is set to configure a low-power multi-hop network and a WiFi route 120 is set using some terminals in the Bluetooth route 110 when necessary, so that a high-throughput low-delay multi-hop network is set.

Bluetooth is an industrial standard for wireless personal area communication and is standardized by the Bluetooth Special Interest Group (SIG). Classic Bluetooth before Bluetooth specification version 4.0 is technology for data transmission between devices and is usually used for transmission of photos and videos between wireless headsets or smart devices. With the recent growth of the internet of things (IoT) market, BLE technology for low-power devices has been included in the Bluetooth specification version 4.0. BLE has different physical layer and media access control (MAC) layer characteristic than Classic Bluetooth.

As compared to Classic Bluetooth, BLE reduces power consumption by simplifying a linking procedure and decreasing a physical layer speed and transmission power. In addition, for efficient device discovery, the original number of Bluetooth channels is decreased while the bandwidth of each channel is doubled. Among a total of 40 channels, three channels are defined as control channels called advertising channels and used for device detection and link setup, and the other 37 channels are defined as data channels and used for data transmission after the link setup.

Bluetooth transmits data using frequency hopping to overcome various interferences occurring in a 2.4 GHz industry science medical (ISM) band. The frequency hopping is used in both Classic Bluetooth and BLE. Since Bluetooth technology provides lower transmission speed and shorter transmission range than WiFi technology, Bluetooth technology is not suitable for high-capacity data transmission but has strengths of low-power operation and maintenance of a link between devices.

WiFi is local area network communication technology and is standardized by the Institute of Electrical and Electronics Engineers (IEEE) under the IEEE 802.11 series of standards. WiFi allows a medium to be shared by a plurality of users using carrier sense multiple access with collision avoidance (CSMA/CA) technique. A terminal having data to be transmitted checks whether a medium is available during a fixed period of time, i.e., distributed coordination function (DCF) interframe spacing (DIFS). The terminal stops trying to transmit the data when another terminal is using the medium. When the medium is available during the DIFS, the terminal selects a random number in a fixed range. Thereafter, when the medium is available for one slot, i.e., nine microseconds, the terminal decreases the random number by one. When another terminal is using the medium for one slot, the terminal immediately stops trying to transmit the data. When the random number becomes zero through this procedure, the terminal occupies the medium and transmits the data.

As compared to Bluetooth, WiFi enables high-throughput low-delay communication but consumes more energy due to a CSMA/CA sharing technique because, in a state where an interface is on, a medium needs to be continuously sensed even when a terminal is not sending data. In addition, WiFi has a longer transmission distance than Bluetooth and thus requires more energy for data transmission.

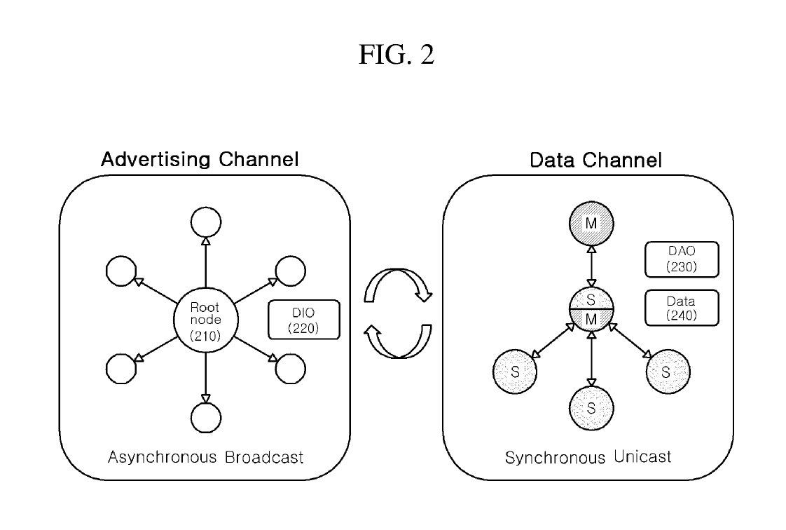

FIG. 2 schematically shows configuration of a low-power multi-hop network, according to an embodiment of the present invention.

A low-power multi-hop network is configured by operating a routing protocol optimally for a low-power communication MAC layer. In an embodiment of the present invention, a low-power multi-hop network is configured using BLE and routing protocol for low-power lossy network (RPL) technologies, but it is apparent to those skilled in the art that a low-power multi-hop network may be configured using other technologies.

According to an embodiment of the present invention, in configuration of a low-power multi-hop network, a node sets a link with each of at least two neighboring nodes including a previous node and a next node on a route from a source to a destination. At this time, the node may be a master node or a slave node in the relationship with a neighboring node. A master node controls link setup with respect to a slave node. For example, the node acts as a master with respect to the previous node in the route and acts as a slave with respect to a next node in the route. The embodiment is distinguished from a conventional method in which a node acts as only either a master or a slave in single-hop Bluetooth.

RPL is a routing technique for performing routing between devices by forming a destination oriented directed acyclic graph (DODAG) having a tree topology in which a plurality of nodes in a network are oriented toward a single root node (e.g., a gateway node or a destination node). RPL provides a function of discovering a neighboring node and a function of selecting a parent node to form a DODAG. RPL uses a DODAG information object (DIO) control message 220 and a destination advertisement object (DAO) control message 230 to periodically form and maintain a DODAG.

At least one root node 210 exists in an RPL network. The root node 210 generates and broadcasts the DIO control message 220 to an advertising channel to announce the presence thereof. When a neighboring node receives the DIO control message 220 from the root node 210 and does not belong to another RPL network, the neighboring node adds an address of a parent node to a parent address table and creates an upstream link. The DIO control message 220 includes rank information indicating a distance between the root node 210 and a DIO transmitting node. According to an embodiment of the present invention, the parent node refers to a node that comes next to the neighboring node in a route to a destination during upstream traffic transmission, and the neighboring node becomes a child node of the parent node.

The neighboring node sends the DAO control message 230, which includes information on the neighboring node, to the root node 210, thereby enabling downstream traffic transmission from the root node 210 afterward. The root node 210 adds the neighboring node to a child address table and creates a downstream link to the neighboring node, so that a route is set. The root node 210 continuously broadcasts the DIO control message 220 in increasing time intervals to maintain the route.

Meanwhile, the neighboring node broadcasts the DIO control message 220, which includes information about an RPL network to which the neighboring node belongs, an address of the neighboring node, and route information, to the advertising channel. A procedure for broadcasting the DIO control message 220 is repeated until all other nodes, which have a longer distance to the root node 210 than the neighboring node, participate in the RPL network.

Each node determines neighboring nodes, which are close to the root node 210, based on the rank information in the DIO control message 220 and selects a closest neighboring node as a parent node, so that a DODAG is formed. According to an embodiment of the present invention, each node additionally considers a link state between the node and a parent node candidate besides the rank information when selecting a parent node. For this, each node includes an adaptation layer between BLE and RPL (ALBER) which operates between RPL and a Bluetooth module. The ALBER estimates a link state between a current node and a parent node candidate and provides an estimated value to the RPL, thereby allowing the RPL to consider the link state between the current node and the parent node candidate in addition to the rank information when selecting a parent node. Thereafter, each node exchanges data 240 with the parent node over a data channel along the route that has been set.

After the route is set, each node may change its parent node for a reason such as a change in an RPL network topology or a link state. The ALBER of each node dynamically changes the selected parent node through interactions with the RPL and the Bluetooth module.

According to the current embodiment, a multi-hop network, which is robust to external interference, may be configured and maintained using low power based on the frequency hopping characteristics of Bluetooth.

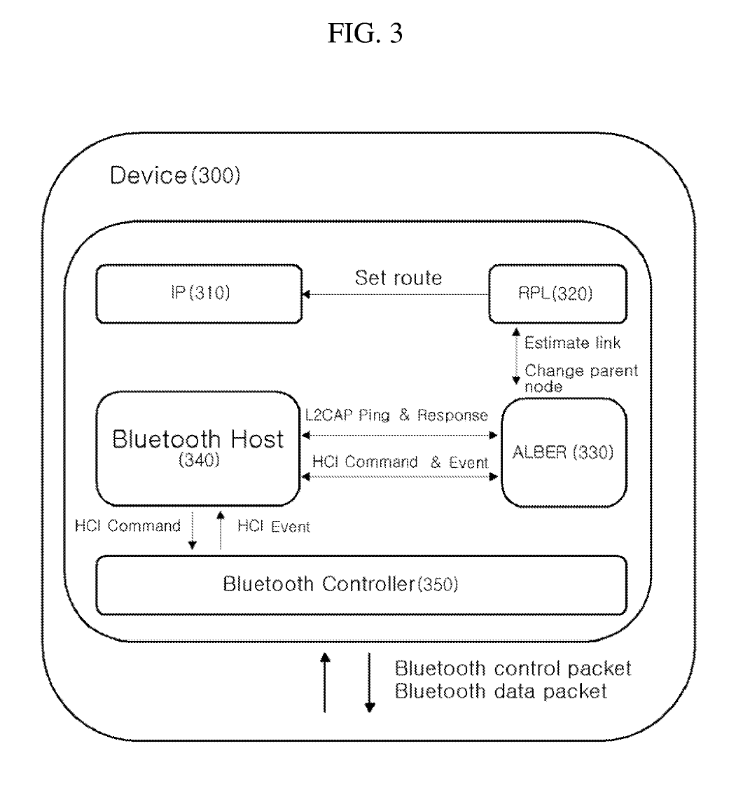

FIG. 3 schematically shows a protocol stack of a device (or a node) 300, according to an embodiment of the present invention.

According to an embodiment of the present invention, the device 300 sets a route in an internet protocol (IP) unit 310 based on a DODAG formed by an RPL unit 320.

According to an embodiment of the present invention, the device 300 includes an ALBER 330 operating between the RPL unit 320 and a Bluetooth host 340. The ALBER 330 estimates a link state with a parent node candidate and provides an estimated value to the RPL unit 320, thereby enabling the RPL unit 320 to additionally consider the link state with the parent node candidate besides rank information when the RPL unit 320 selects a parent node. To estimate the link state with the parent node candidate, the ALBER 330 generates an L2CAP ping and estimates the link state based on a round trip time (RTT) value of an L2CAP response packet received in response to the L2CAP ping. This will be described in detail below.

The Bluetooth host 340 receives the L2CAP ping from the ALBER 330 and controls a Bluetooth controller 350 to transmit the ping to a Bluetooth medium. The Bluetooth controller 350 includes a Bluetooth physical layer and a MAC layer. The Bluetooth host 340 transmits the L2CAP response packet received by the Bluetooth controller 350 to the ALBER 330.

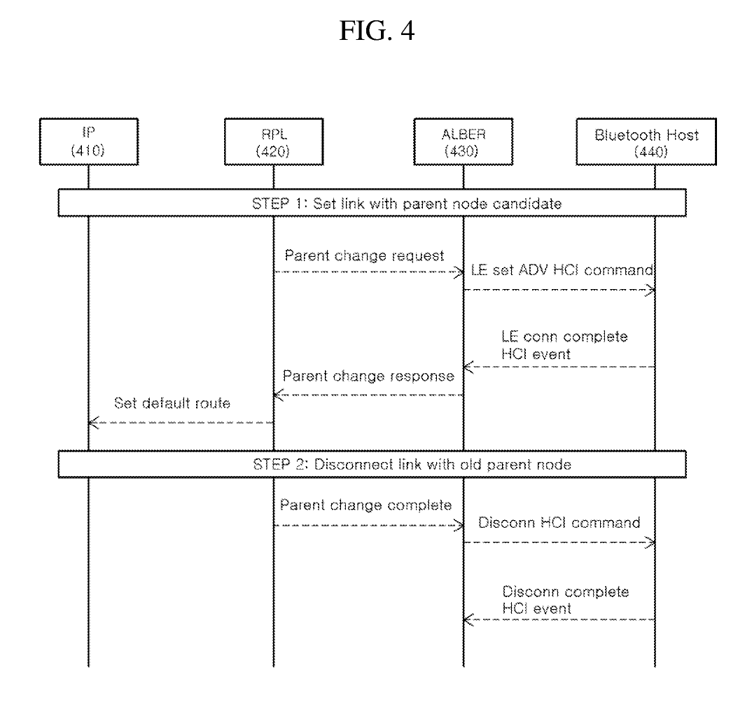

According to an embodiment of the present invention, the ALBER 330 dynamically changes the selected parent node through interactions with the RPL unit 320 and the Bluetooth host 340. The ALBER 330 performs a parent node changing procedure together with the RPL unit 320 using primitives, which will be described below with reference to FIG. 4. The ALBER 330 performs the parent node changing procedure together with the Bluetooth host 340 using a host controller interface (HCI) command and a response event. The Bluetooth host 340 sends the HCI command to the Bluetooth controller 350 to control the Bluetooth controller 350 to transmit the HCI command to a Bluetooth medium and transmits an HCI event from the Bluetooth controller 350 to the ALBER 330.

According to an embodiment of the present invention, the device 300 estimates a link state with a parent node. In detail, the ALBER 330 estimates a link state with a parent node candidate and provides an estimated value to the RPL unit 320, thereby enabling the RPL unit 320 to additionally consider the link state with the parent node candidate besides rank information when the RPL unit 320 selects a parent node. According to the current embodiment, the ALBER 330 estimates the link state using an RTT. RTT refers to a time taken for a packet to travel a round trip to the other party. To estimate the link state with the parent node candidate, the ALBER 330 generates an L2CAP ping and estimates the link state based on an RTT value of an L2CAP response packet received in response to the L2CAP ping.

According to an embodiment of the present invention, RTT increases by a connection interval, T_{CI}, each time packet transmission fails. This is because, when the device 300 fails in packet transmission, the device 300 delays retransmission until starting a next link event after finishing a current link event. Accordingly, each retransmission is delayed by T_{CI}. According to an embodiment of the present invention, the number of connection intervals, N_{CI}, is defined as Equation 1, where N_{CI} indicates the number of retransmissions plus 1.

$${N}_{CI} = ⌊ \frac{RTT}{{T}_{CI}} ⌋ . \qquad ( 1 )$$

According to an embodiment of the present invention, a representative value, i.e., the expected number of connection intervals, E_{CI}, is obtained based on N_{CI} values measured a plurality of times, so that a link state with a parent node is estimated. E_{CI} is an exponentially weighted moving average of N_{CI} values. The earlier an N_{CI} value is obtained, a less weight is applied. According to an embodiment of the present invention, E_{CI} is used as a representative value, but the present invention is not limited to the embodiment. It is apparent to those skilled in the art that other representative values may be used.

According to an embodiment of the present invention, the RPL unit 320 defines a route value, R(Pₙ), for a parent node candidate, Pₙ, as Equation 2. The route value is a distance RANK(Pₙ) from the parent node candidate to a root node plus a value obtained by applying a weight, α, to an estimated value, E_{CI}(n, Pₙ), of a link state with the parent node candidate. According to an embodiment of the present invention, the route value is calculated by adding a distance from a parent node candidate to a root node and an estimated value of a link state with the parent node candidate under the condition that a weight is 1, but the present invention is not limited to the embodiment. It is apparent to those skilled in the art that other values may be used. According to another embodiment of the present invention, the RPL unit 320 may set a weight to a value less than 1, thereby reflecting more the distance from a parent node candidate to a root node. The RPL unit 320 selects a parent node candidate giving the least route value as a parent node.

R(Pₙ)RANK(Pₙ)+αE_{CI}(n,Pₙ). (2)

FIG. 4 schematically shows a parent node changing procedure in a low-power multi-hop network, according to an embodiment of the present invention.

According to an embodiment of the present invention, a parent node is changed for a reason such as a change in an RPL network topology or a link state. However, it is apparent to those skilled in the art that the reason of a change of a parent node is not limited. An ALBER 430 determines whether to change a parent node, taking account of an RPL network topology or a link state. The device 300 constantly performs a parent node changing procedure to reduce inefficient packet loss occurring while changing a parent node. For this, the ALBER 430 tries to link with a new parent node first through interactions with an RPL unit 420 and a Bluetooth host 440 and then performs a procedure for changing a parent according to the result.

According to an embodiment of the present invention, the ALBER 430 performs a parent node changing procedure together with the RPL unit 420 using a PARENT CHANGE REQUEST primitive and a PARENT CHANGE RESPONSE primitive. According to an embodiment of the present invention, the ALBER 430 performs the parent node changing procedure together with the Bluetooth host 440 using an HCI command and a response event.

In detail, the ALBER 430 receives a PARENT CHANGE REQUEST for selecting a new parent node from the RPL unit 420. The ALBER 430 does not rush to update a routing table but sends a LE SET ADV HCI COMMAND to the Bluetooth host 440, so that the Bluetooth host 440 sets a link with the new parent node. After setting the link with the new parent node, the Bluetooth host 440 informs the ALBER 430 of the result using a LE CONN COMPLETE HCI EVENT. When receiving the LE CONN COMPLETE HCI event indicating a linking success from the Bluetooth host 440, the ALBER 430 sends a PARENT CHANGE RESPONSE indicating a linking success to the RPL unit 420. The RPL unit 420 changes an old default route of an IP unit 410 to the new parent node using SET DEFAULT ROUTE.

When the ALBER 430 does not receive the LE CONN COMPLETE HCI EVENT a certain time after the ALBER 430 sends the LE SET ADV HCI COMMAND to the Bluetooth host 440, the ALBER 430 sends a PARENT CHANGE RESPONSE indicating a linking failure to the RPL unit 420. The RPL unit 420 selects another parent node, and the parent node changing procedure is repeated.

According to an embodiment of the present invention, the ALBER 430 performs a procedure for disconnecting a link with an old parent node together with the RPL unit 420 using a PARENT CHANGE COMPLETE primitive. According to an embodiment of the present invention, the ALBER 430 performs the procedure for disconnecting a link with an old parent node together with the Bluetooth host 440 using an HCI command and a response event.

According to an embodiment of the present invention, the ALBER 430 receives PARENT CHANGE COMPLETE indicating the completion of a route table update from the RPL unit 420. The ALBER 430 sends a DISCONN HCI COMMAND to the Bluetooth host 440 to disconnect a link with an old parent node and receives a DISCONN COMPLETE HCI EVENT indicating the disconnection result from the Bluetooth host 440.

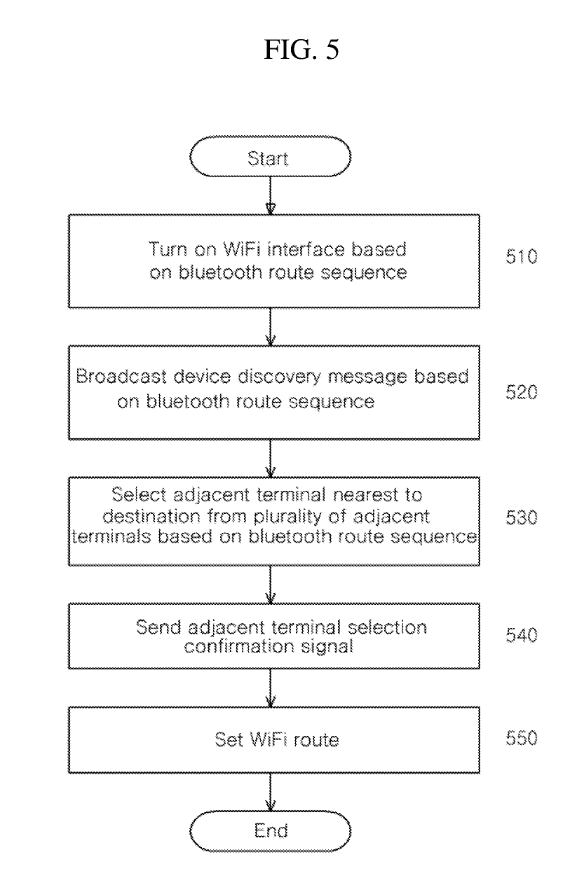

FIG. 5 is a flowchart of a procedure for setting a WiFi route of a WiBLE network, according to an embodiment of the present invention.

The WiBLE device 100 turns on a WiFi interface when it is its turn based on a Bluetooth route sequence in operation 510. The WiBLE device 100 obtains Bluetooth route information from the RPL unit 320. The Bluetooth route information includes a Bluetooth route sequence and participation or non-participation of the WiBLE device 100 in a Bluetooth route. According to an embodiment of the present invention, the Bluetooth route sequence refers to a route value used to configure the Bluetooth route. As such, WiFi interfaces of WiBLE devices 100 on the Bluetooth route are turned on.

The WiBLE device 100 broadcasts a device discovery message when it is its turn based on the Bluetooth route sequence in operation 520. The WiBLE device 100 obtains adjacent terminal information based on the device discovery message. According to an embodiment of the present invention, the device discovery message may be a beacon packet but is not limited thereto. It is apparent to those skilled in the art that the device discovery message may be any other packet for obtaining the adjacent terminal information.

The WiBLE device 100 selects an adjacent terminal, which is nearest to a destination, from a plurality of adjacent terminals based on the Bluetooth route sequence in operation 530.

The WiBLE device 100 sends an adjacent terminal selection confirmation signal to the selected adjacent terminal in operation 540 unless the WiBLE device 100 is the destination.

When each of the devices from a source to the destination sequentially confirms an adjacent terminal thereof, a WiFi route is set in operation 550.

According to an embodiment of the present invention, when the WiBLE device 100 participates in a Bluetooth route but not in a WiFi route, the WiBLE device 100 turns off a WiFi interface. According to an embodiment of the present invention, unless the WiBLE device 100 is a source, the WiBLE device 100 turns off a WiFi interface when the WiBLE device 100 does not receive an adjacent terminal confirmation signal within a certain time after turning on the WiFi interface. However, the present invention is not limited to the current embodiment. It is apparent to those skilled in the art that whether to participate in a WiFi route may be determined using other methods.

According to an embodiment of the present invention, the WiBLE device 100 selected to be on a WiFi route may selectively perform a control procedure for preventing channel occupation of terminals off the WiFi route. The WiBLE device 100 selected to be on the WiFi route performs the control procedure when it is its turn based on a WiFi route sequence. According to an embodiment of the present invention, the WiBLE device 100 selected to be on a WiFi route broadcasts a WiFi medium reservation message or a Bluetooth control message for prohibiting WiFi transmission. The WiFi medium reservation message may be a clear to send (CTS) control packet or a null data packet but is not limited thereto. It is apparent to those skilled in the art that the control procedure may be performed using other control messages.

According to the current embodiment, a multi-hop network may be configured to maintain low-power consumption and enable high-throughput low-delay communication when necessary. For this, a low-power multi-hop network is configured first, and then an optimal high-throughput low-delay multi-hop network including only some terminals of the low-power multi-hop network is set using the low-power multi-hop network when necessary, so that energy consumption is minimized, and therefore, the lifespan of an entire network is maximized and necessary services are effectively provided. Accordingly, a WiBLE network may be effectively used in communication shadow, in which communication with infrastructure is not available, and may have a maximized lifespan as compared to a multi-hop network using a single interface. For example, in disaster or emergency situations in which communication with infrastructure is not available because of collapse of a building, mobile phones of survivors and robots deployed by rescue teams may form a WiBLE network, thereby enabling the survivors to exchange audio and video signals with the rescue teams, so that a rescue success rate may be increased. In addition, even in communication shadow, in which communication with infrastructure is not available, during outdoor leisure activities, communication environments may be provided for participants in the outdoor leisure activities. According to the current embodiment, when a low-power multi-hop network is configured, a multi-hop network, which is robust to external interference, may be configured with low power using the frequency hopping characteristics of Bluetooth.

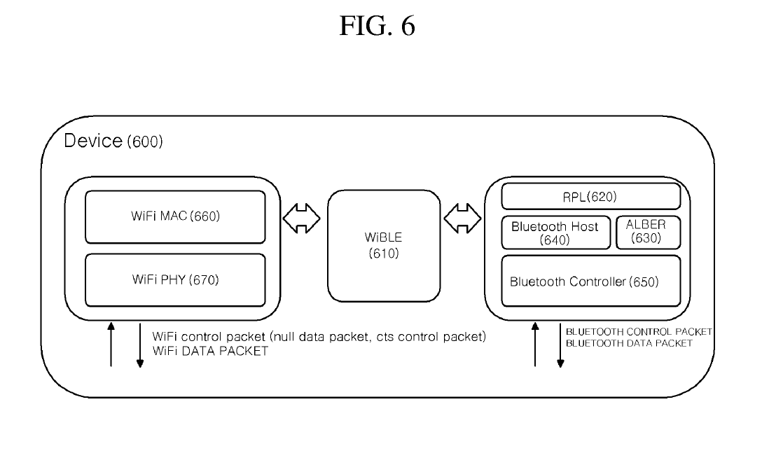

FIG. 6 schematically shows a structure of a device 600 according to an embodiment of the present invention.

The device 600 includes a WiBLE unit 610, a WiFi MAC unit 660, a WiFi physical layer (PHY) unit 670, an RPL unit 620, an ALBER 630, a Bluetooth host 640, and a Bluetooth controller 650. According to an embodiment of the present invention, the WiBLE unit 610 operates as a controller that configures a WiBLE network.

The WiBLE unit 610 obtains Bluetooth route information from the RPL unit 620. The Bluetooth route information includes a Bluetooth route sequence and participation or non-participation of the device 600 in a Bluetooth route. According to an embodiment of the present invention, the Bluetooth route sequence refers to a route value used to configure the Bluetooth route. When the device 600 participates in the Bluetooth route, the WiBLE unit 610 controls the WiFi MAC unit 660 and the WiFi PHY unit 670 to turn on a WiFi interface when it is its turn based on the Bluetooth route sequence.

When the device 600 participates in the Bluetooth route, the WiBLE unit 610 controls the WiFi MAC unit 660 and the WiFi PHY unit 670 to broadcast a device discovery message when it is its turn based on the Bluetooth route sequence. The device 600 obtains adjacent terminal information based on a device discovery message received from an adjacent terminal. According to an embodiment of the present invention, the device discovery message may be a beacon packet but is not limited thereto. It is apparent to those skilled in the art that the device discovery message may be any other packet for obtaining the adjacent terminal information. The WiBLE unit 610 selects an adjacent terminal, which is nearest to a destination, from a plurality of adjacent terminals based on the Bluetooth route sequence.

The WiBLE unit 610 controls the Bluetooth host 640 and the Bluetooth controller 650 to send an adjacent terminal selection confirmation signal to the selected adjacent terminal unless the device 600 is the destination. When each of the devices from a source to the destination sequentially confirms an adjacent terminal thereof, a WiFi route is set.

When the device 600 participates in the Bluetooth route but not in the WiFi route, the WiBLE unit 610 controls the WiFi MAC unit 660 and the WiFi PHY unit 670 to turn off the WiFi interface. According to an embodiment of the present invention, unless the device 600 is a source, the WiBLE unit 610 may control the WiFi MAC unit 660 and the WiFi PHY unit 670 to turn off the WiFi interface when the WiBLE unit 610 does not receive an adjacent terminal confirmation signal within a certain time after turning on the WiFi interface. However, the present invention is not limited to the current embodiment. It is apparent to those skilled in the art that whether to participate in a WiFi route may be determined using other methods.

The WiBLE unit 610 of the device 600 selected to be on the WiFi route may selectively perform a control procedure for preventing channel occupation of terminals off the WiFi route. The device 600 performs the control procedure when it is its turn based on a WiFi route sequence. According to an embodiment of the present invention, the device 600 selected to be on a WiFi route broadcasts a WiFi medium reservation message or a Bluetooth control message for prohibiting WiFi transmission. The WiFi medium reservation message may be a CTS control packet or a null data packet but is not limited thereto. It is apparent to those skilled in the art that the control procedure may be performed using other control messages.

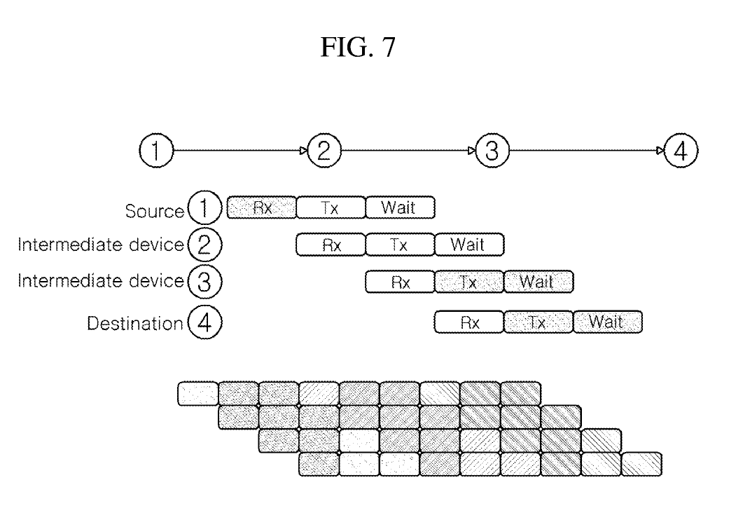

FIG. 7 schematically shows data channel status of the device 600, according to an embodiment of the present invention.

When all devices on a WiFi route use one channel, the WiFi MAC unit 660 of the device 600 maintains three states, i.e., a receive state, a transmit state, and a wait state. The device 600 divides time into the three states and repeats the receive state, the transmit state, and the wait state. When the device 600 is a source, a packet is generated from an internal application of the device 600, and therefore, the device 600 does nothing when a data channel is the receive state. When the device 600 is a destination, the device 600 is a destination of a packet received through the WiFi route, and therefore, the device 600 does nothing when the data channel is in the transmit state. The device 600 receives a packet from a preceding terminal on the WiFi route and transmits the packet to a succeeding terminal. Since the device 600 enters the wait state after transmitting the packet, the device 600 does not hinder packet transmission of the succeeding device on the WiFi route. According to an embodiment of the present invention, the device 600 turns off a WiFi interface when the device 600 is in the wait state or does nothing.

When adjacent channels of respective devices 600 on a WiFi route are different from each other, the WiFi MAC unit 660 of each device 600 maintains two states, i.e., a receive state and a transmit state. The device 600 divides time into the two states and repeats the receive state and the transmit state. When the device 600 is a source, the device 600 does nothing in the receive state. When the device 600 is a destination, the device 600 does nothing in the transmit state. The device 600 receives a packet from a preceding terminal on the WiFi route and transmits the packet to a succeeding terminal. Since adjacent channels on the WiFi route are different from each other, the device 600 immediately receives a next packet. According to an embodiment of the present invention, the device 600 turns off a WiFi interface when the device 600 does nothing.

According to the current embodiment, a data transmission technique eliminating a procedure, in which terminals on a set WiFi route compete each other to occupy a medium, is used, so that unnecessary energy consumption may be minimized, data transmission efficiency may be maximized, and high-throughput low-delay service may be provided. In addition, a WiFi interface is turned off when a terminal is in a wait state or does nothing, so that unnecessary energy consumption may be minimized.

While the present invention has been particularly shown and described with reference to embodiments thereof, it will be understood that various changes in form and details may be made therein without departing from the spirit and scope of the following claims.

For example, the device 600 according to some embodiments of the present invention may also include a bus connected to each element of a device as shown in FIG. 6, at least one processor connected to the bus, and memory connected to the bus to store commands, received messages, or generated messages. The memory is also connected to the at least one processor which executes the commands.

The present invention can also be embodied as computer-readable codes on a computer-readable recording medium. The computer-readable recording medium is any data storage device that can store data which can be thereafter read by a computer system. Examples of the computer-readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer-readable recording medium can also be distributed over network coupled computer systems so that the computer-readable code is stored and executed in a distributed fashion.

1. A device for configuring a multi-hop network, the device comprising a controller configured to set a second network comprising some terminals of a first network, the first network and the second network being the multi-hop network, the first network being built using a first communication interface characterized by low power, and the second network being built using a second communication interface having a longer transmission distance than in the first network.

2. The device of claim 1, wherein the controller turns on the second communication interface when it is its turn based on a route sequence for the first network.

3. The device of claim 1, wherein the controller controls a device discovery message to be broadcast through the second communication interface when it is its turn based on a route sequence for the first network, and the controller obtains information on a plurality of adjacent terminals based on a device discovery message received from each of the plurality of adjacent terminals through the second communication interface.

4. The device of claim 3, wherein the device discovery message is a WiFi beacon packet.

5. The device of claim 3, wherein the controller selects an adjacent terminal from the plurality of adjacent terminals based on the route sequence for the first network, the adjacent terminal being nearest to a destination.

6. The device of claim 5, wherein the second network comprises the adjacent terminal nearest to the destination.

7. The device of claim 5, wherein the controller controls an adjacent terminal selection confirmation signal to be sent to the adjacent terminal nearest to the destination through the first communication interface.

8. The device of claim 7, wherein the controller turns off the second communication interface when the device is not a source and does not receive the adjacent terminal selection confirmation signal within a certain time.

9. The device of claim 1, wherein the controller controls a control message to be broadcast when it is its turn based on a route sequence for the second network, the control message being for prohibiting channel occupation of terminals which do not participate in the second network.

10. The device of claim 9, wherein the control message is at least one of a WiFi clear to send (CTS) control packet, a WiFi null data packet, and a Bluetooth control packet.

11. The device of claim 1, wherein the first communication interface is a Bluetooth interface.

12. The device of claim 1, wherein the second communication interface is a WiFi interface.

13. A method of configuring a multi-hop network, the method comprising setting a second network comprising some terminals of a first network, the first network and the second network being the multi-hop network, the first network being built using a first communication interface characterized by low power, and the second network being built using a second communication interface having a longer transmission distance than in the first network.

14. The method of claim 13, wherein the setting of the second network comprises turning on the second communication interface based on a route sequence for the first network.

15. The method of claim 13, wherein the setting of the second network comprises:
broadcasting a device discovery message through the second communication interface based on a route sequence for the first network; and
obtaining information on a plurality of adjacent terminals based on a device discovery message received from each of the plurality of adjacent terminals through the second communication interface.

16. The method of claim 15, wherein the device discovery message is a WiFi beacon packet.

17. The method of claim 15, wherein the setting of the second network comprises selecting an adjacent terminal from the plurality of adjacent terminals based on the route sequence for the first network, the adjacent terminal being nearest to a destination.

18. The method of claim 17, wherein the second network comprises the adjacent terminal nearest to the destination.

19. The method of claim 17, wherein the setting of the second network comprises sending an adjacent terminal selection confirmation signal to the adjacent terminal nearest to the destination through the first communication interface.

20. A computer-readable recording medium having recorded thereon a program for executing the method of claim 13.
